(19) United States
(12) Patent Application Publication
(10) Pub. No.: US 2013/0020733 A1
(43) Pub. Date: Jan. 24, 2013

(54) Apparatus and Method for Creating Spacer Lattice

(71) Applicant: Richard Berger, Chicago, IL (US)

(72) Inventor: Richard Berger, Chicago, IL (US)

(21) Appl. No.: 13/559,742

(22) Filed: Jul. 27, 2012

Related U.S. Application Data
(63) Continuation-in-part of application No. 13/303,481, filed on Nov. 23, 2011.
(60) Provisional application No. 61/416,355, filed on Nov. 23, 2010.

(51) Int. Cl. B29C 67/24; B29C 33/00

(52) U.S. Cl. 264/40.1; 425/470

(57) ABSTRACT

A spacer apparatus can be employed to achieve improved fit and balance in a knee joint in knee arthoplasty without requiring multiple cuts to the distal femur or proximal tibia. The spacer apparatus can be molded by using a semi-rigid or rigid one- or two-piece mold to form biocompatible material in liquid or gel form into a desired shape and thickness appropriate for the patient, allowing the material to cure or harden, and then removing the material from the mold. The spacer apparatus can also be molded by using a semi-rigid or rigid one- or two-piece mold to form biocompatible material in liquid or gel form into a desired shape and thickness, allowing the material to cure or harden, and then further cutting or forming the material into a desired shape appropriate for the patient.

### CROSS-REFERENCES TO RELATED APPLICATIONS

This application claims priority to provisional application Ser. No. 61/416,355, filed on Nov. 23, 2010 by Dr. Richard Berger and nonprovisional application Ser. No. 13/303,481 filed by Dr. Richard Berger on Nov. 23, 2011.

This application is related to PCT application no. PCT/US2011/062023 titled “Spacer Apparatus and Method for Achieving Improved Fit and Balance in Knee Joints filed on Nov. 23, 2011 by Dr. Richard Berger.

All of these applications are incorporated herein in their entirety by reference.

### STATEMENT REGARDING FEDERALLY SPONSORED RESEARCH OR DEVELOPMENT

Not applicable

### BACKGROUND

Knee replacement surgery, also known as knee arthoplasty, is an important course of treatment for a number of problems that can occur with respect to the knee joint. Knee arthoplasty can be used as a treatment modality for chronic knee pain and various knee dysfunctions, including arthritis. Knee arthoplasty can be necessitated by acute injuries, as well as chronic or degenerative conditions.

The knee joint is generally defined as the point of articulation of the femur with the tibia. The knee joint consists of bony structures, primarily including the distal femur, the proximal tibia, and the patella. The knee also contains soft tissue and ligaments within and surrounding these structures, the primary purpose of which is to provide stability of the joint and to provide a shock-absorbing cushion between the distal femur and the proximal tibia.

A number of conditions or injuries can cause deterioration or dysfunction resulting in direct contact between the distal femur and proximal tibia. Such direct contact results in significant pain and reduced function. One of the purposes of knee arthoplasty is to replace knee structures, particularly the distal end of the femur and/or the proximal end of the tibia, with prosthetic replacement structures, known as implants, to re-establish a stable, balanced joint capable of smooth, pain-free movement.

Knee arthoplasty often involves work on all three bony structures within the knee. One step, resurfacing of the patella, is relatively easy to accomplish and is often performed in a single step. A significant portion of the remainder of the knee arthoplasty procedure is preparation of the distal femur and proximal tibia to receive femoral and tibial implants, respectively. This preparation typically requires a number of precise cuts to the distal femur and proximal tibia.

One of the existing challenges of knee arthoplasty is fitting femoral and tibial implants to the femur and tibia, respectively, in such a manner that the post-arthoplasty knee joint is not too loose, and is balanced in both the varus/valgus and the anterior/posterior orientations. Appropriate fit and balance are important to the stability and range of motion of the replaced knee joint, and also play a significant role in the durability of the implants and the outcomes experienced by the patient, including range of motion and pain reduction.

One technique for attempting to achieve appropriate fit and balance is to position the tibial and femoral implants in an optimal orientation with respect to each other and to the distal femur and proximal tibia, such orientation being achieved by cutting the distal femur and proximal tibia at angles designed to produce appropriate fit and balance within the knee joint once the implants are placed in connection with the prepared bone surfaces. This technique has several disadvantages. It is often challenging to predict the correct angles and depths of cutting required prior to fitting the implants. Because the fit and balance of the implants relies on the angle and depth of cuts to the tibial and femoral bones, the surgeon is often required to make multiple cuts to these bones prior to finalizing the placement of the implants. Increased cutting results in greater trauma to the patient, longer recovery periods, and a reduced chance of an optimal outcome if subsequent arthoplasty is needed on the same knee joint. Moreover, errors in judgment or execution sometimes cannot be corrected after such cuts are made.

Several techniques have developed to attempt to mitigate these disadvantages. For example, the technique described in U.S. Pat. No. 5,733,292 involves the use of adjustable trial prosthesis components to help assess the accuracy and appropriateness of cuts prior to final fitting of the implants. Measuring devices, such as that described in U.S. Pat. No. 7,578,821, attempt to provide the surgeon with more detailed information pertinent to appropriate placement of the tibial and femoral implants, thus attempting to reduce the number of required cuts. U.S. Pat. No. 5,108,435 describes a method for forming a casting to improve fixation of an implant.

Although some of the techniques and devices described above have improved outcomes for knee arthoplasty, currently available devices and techniques still suffer a number of disadvantages. Currently available devices and techniques do not allow a surgeon performing knee arthoplasty to place tibial and femoral implants reliably so as to achieve proper fit and balance without making multiple trial-and-error cuts to the femur or tibia.

A need exists for new apparatuses and methods for reliably achieving fit and balance in knee joints undergoing knee arthoplasty without a need for multiple cuts to the femur or tibia. Ideally, such apparatuses and methods would permit a surgeon to make adjustments achieve proper fit and balance within the knee joint without requiring multiple cuts to the distal femur or proximal tibia. Such apparatuses and methods would, ideally, be useable in conjunction with a variety of currently-existing arthoplasty devices such as cutting guides, saw blades, and measurement systems.

A need further exists for an apparatus and method for forming such adjustment-enabling apparatuses at the point of care, during arthoplasty procedures, when the specific requirements of the knee can be determined with precision. This permits the possibility of such apparatuses being formed on a custom and as-needed basis, optimally by the same individuals performing or assisting with the arthoplasty procedure. At least some of these objectives are met by the versions of the present invention.

### SUMMARY

The present invention is directed to an apparatus and method for molding spacer lattices that can be used to reliably achieve improved fit and balance in knee joints undergoing knee arthoplasty without a need for multiple cuts to the femur or tibia. Spacer lattices formed by versions of the present invention are weight bearing and intended for permanent or semi-permanent placement in a knee joint to improve the fit and balance of the joint. Such spacer lattices can, by way of example, be used to alter the spacing and angle of orientation of femoral or tibial implants connected to the distal femur or proximal tibia, respectively, for the purpose of achieving better fit and balance in the knee joint. The spacer lattice formed according to versions of the present invention is a lattice made of a biocompatible material that is, when hardened or cured, sufficiently rigid to hold the implant in the desired position and orientation. Preferably, this material is hardened PMMA.

A spacer lattice can be shaped in varying thicknesses and shapes to permit alteration of the fit or balance of tibial or femoral implants. In one version of the invention, a spacer lattice is formed at the point of care by applying appropriate biocompatible material in liquid or gel phase to a semi-rigid mold configured to form a spacer lattice in a pre-selected shape, allowing said biocompatible material to harden, and removing the formed spacer lattice from the mold. In yet another version of the invention, biocompatible material in liquid or gel phase is applied to a semi-rigid mold configured to form a sheet of spacer lattice, allowing said biocompatible material to harden, removing the spacer lattice sheet from the mold, and cutting said spacer lattice sheet to one or more spacers of desired shape. In yet another version of the invention, appropriate biocompatible material in liquid or gel phase is applied to a rigid mold with a mold screen pocket configured to form sheet of spacer lattice, allowing said biocompatible material to harden, removing the spacer lattice sheet from the mold using a mold screen, and cutting said spacer lattice sheet to one or more spacers of desired shape. In yet another version of the invention, appropriate biocompatible material in liquid or gel phase is applied to a rigid mold with a mold screen pocket configured to form a spacer lattice of a pre-selected shape, allowing said biocompatible material to harden, and removing the spacer lattice from said mold using a mold screen.

The thickness of the spacer lattice formed by various versions of the invention can be selected by selecting a mold with a desired depth of inlay or a mold screen with a desired depth of pocket. Optionally, the thickness of spacer lattices formed by various versions of the invention can be selected by controlling the amount of biocompatible material applied to the mold to achieve a desired thickness. Optionally, the thickness of spacer lattices formed by various versions of the invention can be selected by altering the depth of a mold screen within a mold, optionally using a shim.

Appropriate biocompatible material in liquid or gel phase can be applied to a mold according to versions of the present invention by any appropriate means. Biocompatible material may be applied to a mold by, for example, pouring, injecting, and troweling, as determined by the user based on convenience and the viscosity of the biocompatible material being used. Appropriate means will be readily apparent to one skilled in the art.

### BRIEF DESCRIPTION OF THE DRAWINGS

These and other features, aspects, and advantages of the present invention will become better understood with regard to the following description and accompanying drawings, where:

FIG. 1 shows a perspective view of a spacer lattice sheet formed by versions of the invention;

FIG. 2 shows a perspective view of a spacer lattice in one shape appropriate for use in connection with a tibial implant;

FIG. 3 shows an exploded view of a spacer lattice formed according to a version of the present invention appropriate for use in connection with a tibial implant and proximal tibia;

FIG. 4 shows a perspective view of a spacer lattice formed according to a version of the present invention in connection with a proximal tibia and tibial implant;

FIG. 5 shows an exploded view of spacer lattices formed according to a version of the present invention appropriate for connection with a distal femur and femoral implant;

FIG. 6 shows a perspective view of spacer lattices formed according to a version of the present invention in connection with a distal femur and femoral implant;

FIG. 7 shows a perspective view of a one-piece semi-rigid mold according to a version of the present invention configured to form a spacer lattice appropriate for use in connection with a femur and femoral implant;

FIG. 8 shows a perspective view of a one-piece semi-rigid mold according to a version of the present invention configured to form a spacer lattice appropriate for use in connection with a tibia and tibial implant;

FIG. 9 shows a perspective view of a two-piece semi-rigid mold according to a version of the present invention configured to form a spacer lattice appropriate for use in connection with a proximal tibia and tibial implant;

FIG. 10 shows a rigid mold configured to form a sheet of spacer lattice material according to a version of the present invention;

FIG. 11 shows a rigid mold, absent mold top, configured to form a spacer lattice in a pre-selected shape appropriate for use in connection with a proximal tibia and tibial implant according to a version of the present invention;

FIG. 12 shows a rigid mold, absent mold top, configured to form spacer lattice in a pre-selected shape appropriate for use in connection with a distal femur tibia and femoral implant according to a version of the present invention.

### DESCRIPTION

The versions of the present invention are directed towards a mold for forming, at the point of care, spacer lattices for use in achieving improved fit and balance in a knee joint in knee arthoplasty, and methods for molding spacer lattices appropriate for use in achieving improved fit and balance in a knee joint in knee arthoplasty at the point of care.

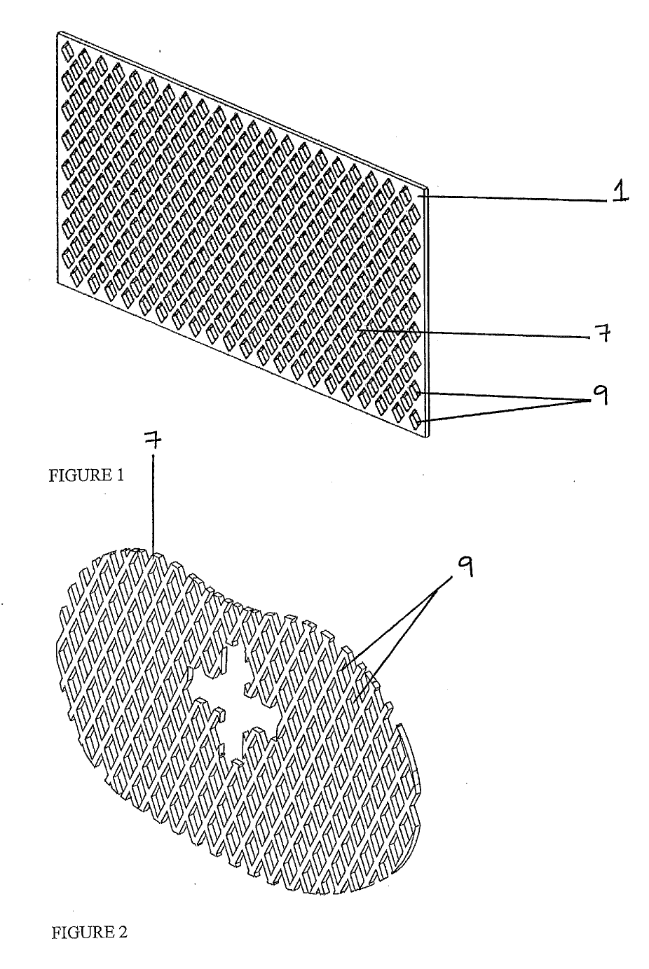

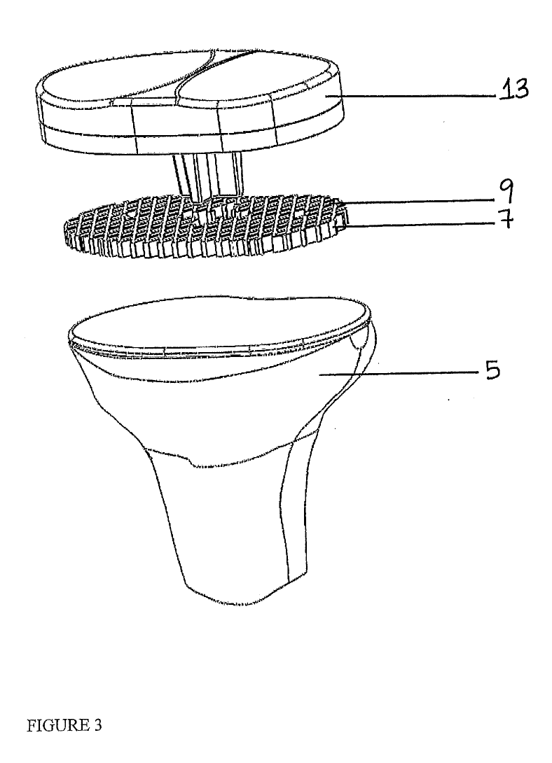

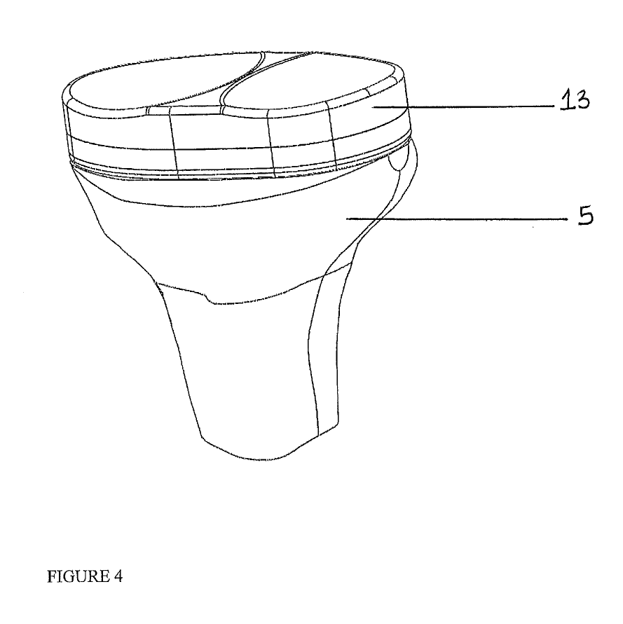

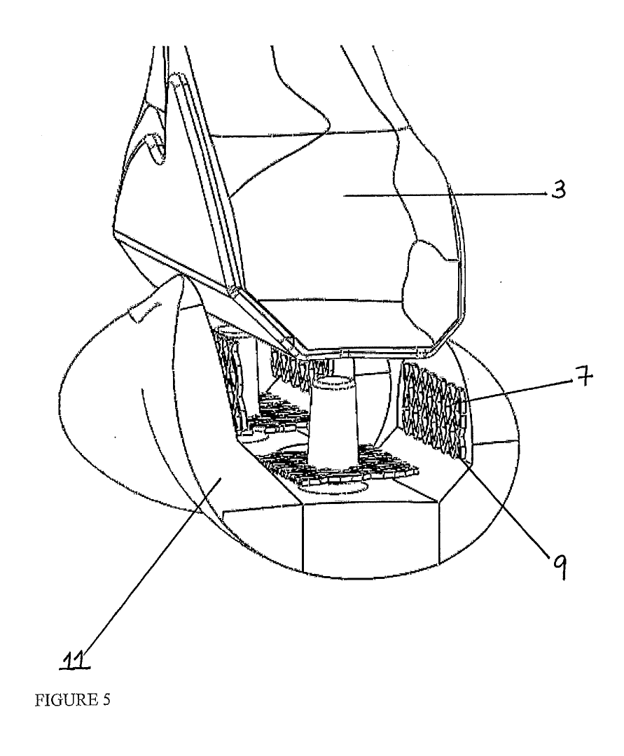

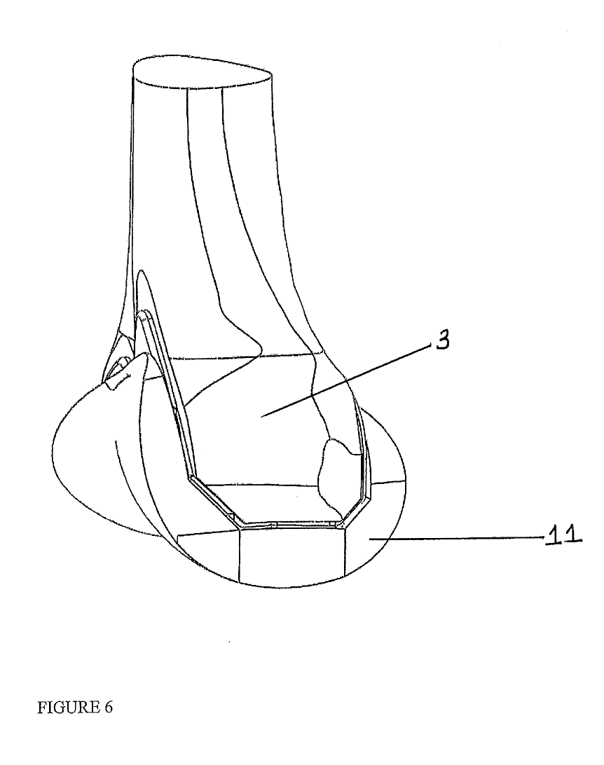

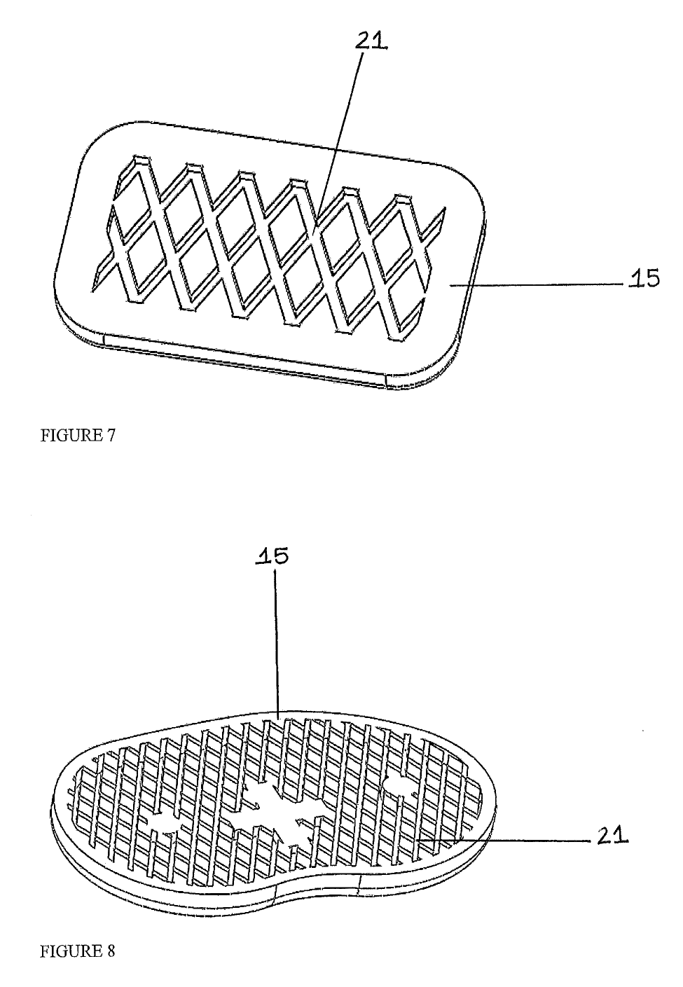

A “spacer lattice” is an apparatus shaped from a lattice structure [1] as shown in FIG. 1 appropriate for use in knee arthoplasty for altering: (1) the distance between a femoral or tibial implant [13] and the prepared bone surfaces of the distal femur [3], as shown in FIG. 7, or proximal tibia [5], as shown in FIG. 8; (2) the tightness or looseness of the knee joint after a distal femur [3] or proximal tibia [5] is prepared to receive a femoral [11] or tibial implant [13]; or (3) the angle of interface between a femoral [11] or tibial implant [13] and the surface of the distal femur [3] or proximal tibia [5]. A spacer lattice molded according to the versions of the present invention may, but need not be, molded in the same shape as that ultimately selected for the spacer as it is used in the arthoplasty procedure. It is within the scope of this invention to mold a spacer lattice that may be further shaped by cutting or grinding.

A spacer lattice can be formed from any biocompatible material that can be applied to a mold in a liquid or gel form and, when hardened or cured, becomes sufficiently rigid to prevent excessive movement of the tibial [13] or femoral [11] implants after the spacer is placed in connection therewith. “Hardened” and “cured” are used interchangeably herein. Preferably, a biocompatible material is selected to provide, when hardened or cured, a sufficient degree of rigidity to hold the knee implants in the desired position while bone cement or other connective substances set, harden, or are placed. Suitable biocompatible materials include, but are not limited to PTFE, ePTFE, other fluropolymers, polyolefin rubber, PET, EVA, or polypropylene, and, preferably, hardened PMMA. While the versions of the spacer lattices depicted and described in specific examples herein are composed of hardened PMMA, other suitable biocompatible materials, including those listed above, are within the scope of the versions of this invention.

A spacer lattice has a lattice structure comprised of arms [7] and pores [9], a version of which is shown in FIG. 2. Pores [9] can be any shape or size, provided: (a) that the spacer lattice, when hardened or cured and placed in connection with a knee joint as described herein, has sufficient rigidity to prevent excessive movement of the tibial or femoral implants; and (b) that the pores [9] can be infiltrated by bone cement or other connective substances commonly used to affix bone implants to bone. Pores [9] may optionally be diamond-shaped. Pores [9] have, further optionally, a size of approximately 6 millimeters by approximately 3 millimeters, the measurements taken across the long and short axes of a single pore [9]. Other pore [9] shapes and sizes may be used within the scope of the invention.

Arms [7] of the spacer lattice can be any shape or size that, when the biocompatible material is hardened or cured, provides sufficient rigidity to prevent excessive movement of the tibial or femoral implants. Arms [7] may optionally be approximately 1 millimeter in width, as shown in FIG. 1. Other lattice arm [7] sizes are within the scope of the invention.

A spacer lattice according to the versions of this invention can be used in “as molded” form, or can be further shaped by grinding or cutting, to be placed in connection with a prepared bone and an implant to achieve desired fit or balance of the knee joint. As used herein, a “spacer lattice” shall designate the “as molded” form of the hardened biocompatible material; and a “spacer” shall designate the shape and portion of the spacer lattice ultimately placed in connection with the prepared bone and implant within the knee. A “spacer lattice” may, but need not, be a “spacer.” “Fit” of the knee joint is the suitability of the interface between a femoral implant [11] and tibial implant [13] determined by the overall distance between the distal end of the femoral implant [11] and the distal femur [3] and/or the overall distance between the proximal end of the tibial implant [13] and the proximal tibia [5] in light of the tension provided by the connective tissue and ligaments of the knee. “Looseness” occurs when the fit of the knee joint is not suitable for desired function of the knee joint, and particularly when the femoral implant [11] and tibial implant [13] are not sufficiently sized and/or located/oriented relative to the overall anatomy to create desired tension in the connective tissue and ligaments of the knee.

“Balance” of the knee joint is the suitability of the interface between a femoral implant [11] and tibial implant [13] to allow desired function of the knee joint, determined by the angle of interface between a femoral implant [11] and distal femur [3] and the angle of interface between the tibial implant [13] and proximal tibia [5] in light of the tension provided by the connective tissue and ligaments of the knee. “Imbalance” occurs when the angle of interface between the faces of the femoral and tibial implants is not suitable for desired function of the knee joint. Imbalance can occur in the varus/valgus orientation, the anterior/posterior orientation, or both. Fit and balance are “improved” when the use of one or more spacer apparatuses, or methods employing the same, reduces or eliminate looseness, imbalance, or both.

A “bone surface” is the surface of a knee joint bone that that has been prepared to receive an implant in a knee arthoplasty procedure. Bone surfaces preferably include prepared surfaces of the distal femur, the proximal tibia, or both.

A “mold” [15] according to the present invention is an apparatus that forms biocompatible material in liquid or gel phase into a spacer lattice of desired thickness with desired arm and pore widths. Preferably, a mold [15] is used to form a spacer lattice at the point of care, on a custom-fit basis for the patient undergoing arthoplasty. Biocompatible material is applied to a mold [15] by any method appropriate for introducing a liquid or gel to a mold, including, for example, pouring, injecting, or troweling. The biocompatible material is allowed to harden or cure within the mold [15]. When the biocompatible material has reached a desired hardness or stage of curing, the spacer lattice is removed from the mold [15]. Optionally, the spacer lattice can be further shaped prior to use as a spacer.

A mold [15] may be made of any material suitable for containing liquid or gel biocompatible material and releasing such material after it has cured or hardened. Suitable materials will be readily recognized by one skilled in the art, and include rigid and semi-rigid polymers, metals and metal alloys, and ceramics. Optionally, a mold [15] according to versions of the present invention can be coated with a release agent prior to the application of liquid or gel biocompatible material to ease the removal of such biocompatible material when it has hardened or cured. Suitable release agents will be readily recognized by one skilled in the art, and include agents such as glycerin.

A spacer lattice formed by the apparatus and method of the versions of this invention may be formed as a sheet, or may be formed in a pre-selected shape. “Shape” according to the versions of this invention means the three-dimensional surface contour of the spacer lattice. Although any shape may be selected within the scope of the versions of this invention, preferable shapes include a spacer of uniform thickness for a tibial implant, a spacer shaped to alter varus/valgus orientation in a tibial implant, a spacer shaped to alter anterior/posterior orientation in a tibial implant, a spacer of uniform thickness for a femoral implant, a spacer shaped to alter varus/valgus orientation in a femoral implant, or a spacer shaped to alter anterior/posterior orientation in a femoral implant.

“Thickness” according to the versions of the present invention is the dimension of a spacer lattice measured from one face of the spacer lattice to the other face. A spacer lattice can be formed according to versions of the present invention with thicknesses in the range of approximately 1 millimeter to 30 millimeters, and preferably of 1 millimeter to 10 millimeters, as desired, to form a spacer appropriate to alter the distance or angle of interface of an implant with the distal femur or proximal tibia, or to alter the fit between an implant and the distal femur or proximal tibia. Spacer lattices with thicknesses below this range may lack sufficient rigidity to prevent excessive movement of the implants, while thicknesses above this range are not typically required for knee arthoplasty or may result in insufficient strength of connective substances such as bone cement. Desired thickness can be achieved by molding a spacer lattice to a pre-selected thickness, or by molding and stacking multiple spacers. Optionally, a spacer can be molded with variable thickness.

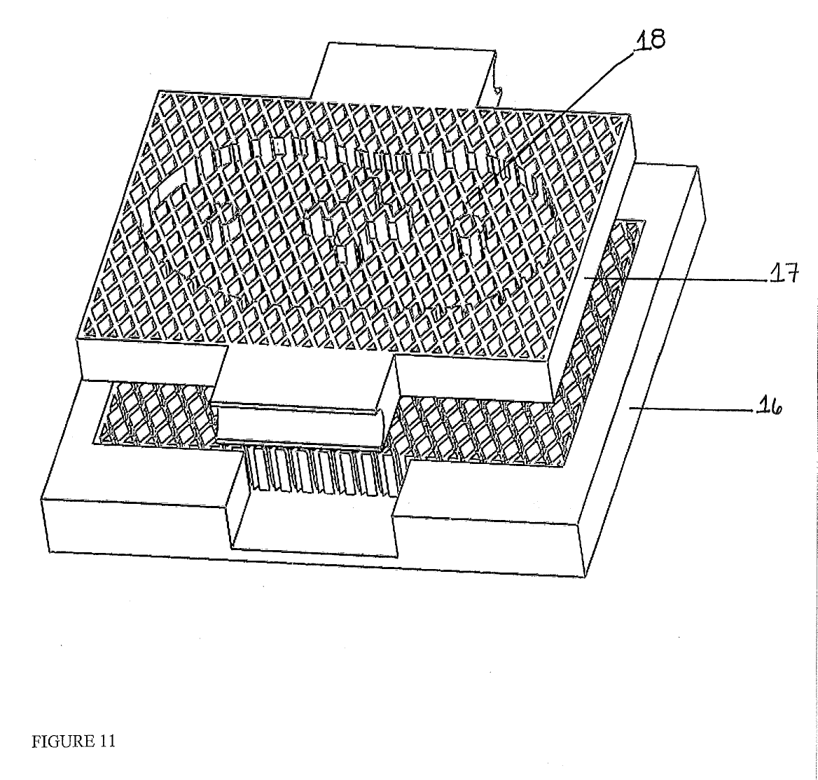

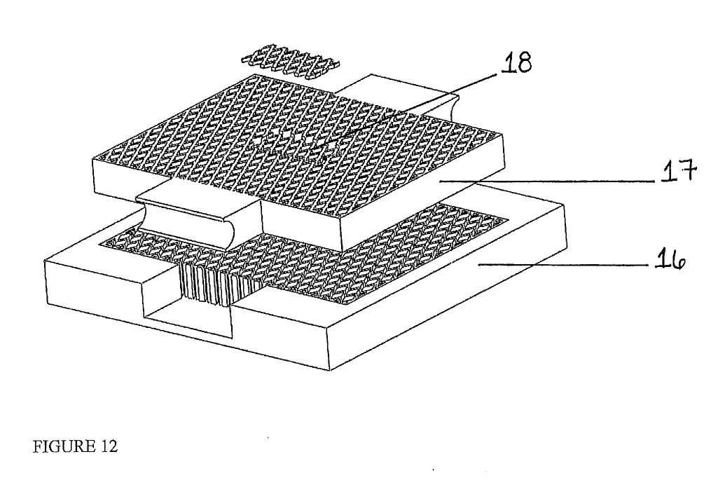

A mold [15] according to versions of the present invention can be configured to form a sheet of spacer material, as shown in FIG. 10, A user can then cut or grind the spacer lattice sheet into one or more spacers of desired shape, and preferably may do so at the point of care, when the bone surface and implants can be measured and the desired adjustments to fit and balance evaluated. A mold according to versions of the present invention may optionally be configured to form a spacer lattice in a pre-selected shape, as shown in FIGS. 7, 8, 9, 11, and 12. It will be readily appreciated by those skilled in the art that other pre-selected shapes, such as those appropriate for use in connection with a femoral implant and distal femur, are within the scope of the invention. It will further be readily appreciated that any desired shape can be formed using a one-piece semi-rigid mold, a two-piece semi-rigid mold, or a rigid mold, all within the scope of the present invention.

A mold [15] according to versions of the present invention may be rigid, as shown in FIGS. 10, 11, and 12. A rigid mold [15] according to these versions of the invention comprises a mold base [16], a mold screen [17], and a mold top [19]. The mold base [16] is configured to form liquid or gel biocompatible material into a spacer lattice with pre-selected arm [7] and pore [9] sizes when such material has hardened or cured. The mold screen [17] is a lattice configured to fit substantially flush into the mold base [16], such that the mold screen [17] can be lifted from or lowered into the mold base [16] to a desired depth. The mold screen [17] may optionally be fitted with handles to assist with lifting or lowering of the mold screen [17] from the mold base [16]. The interface of the mold screen [17] with the mold base [16] defines the bottom surface of the portion of the mold that will form a spacer lattice.

The mold screen [17] is configured with a pocket [18] of a pre-selected shape to form a spacer lattice in that pre-selected shape, as shown in FIG. 14. Optionally, the pocket [18] may be the entire surface of the mold screen [17], as shown in FIG. 10. The thickness of a spacer formed by a mold [15] of these versions of the invention is determined by the depth at which the top surface of the pocket [18] interfaces with the mold base [16]. Accordingly, the thickness of a spacer lattice formed according to these versions of the invention may be altered by selecting a mold screen [17] with a different pocket [18] depth, or, alternatively, by shimming all or part of the mold screen [17] within the mold base [16] to achieve a desired thickness. A spacer with variable thickness across the surface of the spacer may optionally be formed by versions of the present invention in this manner.

Multiple mold screens [17] in differing configurations may be used in conjunction with a single mold base [16] and mold top [19]. This permits the user to select and form spacer lattices in a variety of shapes or thicknesses at the point of care.

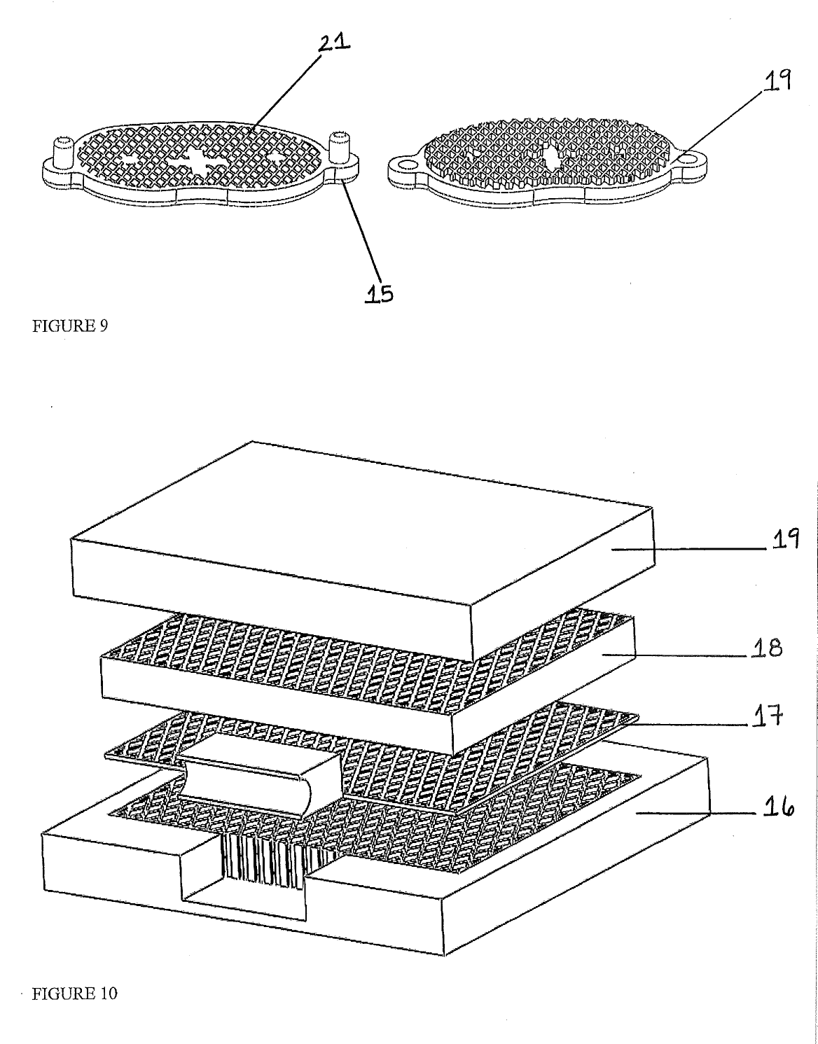

Optionally, a mold according to versions of the present invention can be a semi-rigid mold, as shown in FIGS. 7, 8, and 9. A semi-rigid mold is configured with an inlay [21] of a lattice set to a fixed pre-selected depth. Biocompatible material is applied to the inlay [21] in gel or liquid phase, is permitted to harden or cure, and is removed by twisting, bending, or manipulating the mold. The thickness of the spacer lattice formed by a semi-rigid mold is determined by the depth of the inlay [21]. A semi-rigid mold can consist of a single piece, as shown in FIGS. 7 and 8, or in two pieces, as shown in FIG. 9. It will be appreciated by one skilled in the art that the shapes and thicknesses possible using semi-rigid molds are not restricted to that shape shown by the drawings herein.

The versions of this invention encompass methods for forming a spacer lattice as described herein to improve one or more of fit or balance in a knee joint undergoing knee arthoplasty. A patient undergoing knee arthoplasty is assessed to determine if a spacer is desired to improve fit or balance of the knee joint. A mold [15] according to one or more versions of the present invention is selected to form a spacer lattice of desired shape and thickness. Biocompatible material in liquid or gel phase is applied to the mold and is allowed to harden or cure. The spacer lattice formed by the mold is removed from the mold [15]. Optionally, the spacer lattice is further shaped. One or more spacers are then placed in connection with one or more prepared bone surfaces and implants to alter fit or balance of the knee joint.

It should be noted that the phrase “step of” as implemented in the claims below is distinct from, and not intended to mean, “step for” as that phrase is used in 35 U.S.C. §112 ¶6.

Although the present invention has been described in considerable detail with reference to certain preferred versions thereof, other versions are possible. For example, molds that form spacer lattices with other materials, pore sizes, lattice arm sizes, thicknesses, or shapes may be used other than those described in detail. Similarly, other manners of selecting the shape or depth of the spacer lattice formed by the mold may be employed. Similarly, other steps may be included, or omitted from, the methods of the versions of this invention. Therefore, the spirit and scope of the claims should not be limited to the description of the preferred versions described herein.

What is claimed is:

1: An apparatus comprising a mold configured to form biocompatible material into a spacer lattice.

2: The mold apparatus of claim 1, in which said mold is a semi-rigid mold.

3: The mold apparatus of claim 2, in which said mold further comprises a mold base and a mold top.

4: The mold apparatus of claim 2, in which said mold is configured to form a rectangular sheet of spacer lattice.

5: The mold apparatus of claim 2, in which said mold is configured to form a spacer lattice in a pre-selected shape.

6: The mold apparatus of claim 5, in which said pre-selected shape is a shape appropriate for use in connection with a prepared proximal tibia and a tibial implant.

7: The mold apparatus of claim 5, in which said pre-selected shape is a shape appropriate for use in connection with a prepared distal femur and a femoral implant.

8: The mold apparatus of claim 1, in which said mold is a rigid mold.

9: The mold apparatus of claim 8, in which said mold further comprises a mold base, mold screen, and a mold top.

10: The mold apparatus of claim 9, in which the thickness of said spacer lattice is determined by the depth of said mold screen.

11: The mold apparatus of claim 10, in which the depth of the top surface of said mold screen within said mold base substantially changes at across the mold.

12: The mold apparatus of claim 9, in which said mold screen further comprises a pocket.

13: The mold apparatus of claim 12, in which said pocket is configured to form a spacer lattice in a pre-selected shape and thickness.

14: The mold apparatus of claim 13, in which said pre-selected shape and thickness is a shape and thickness appropriate for use in connection with a prepared proximal tibia and a tibial implant.

15: The mold apparatus of claim 13, in which said pre-selected shape and thickness is a shape and thickness appropriate for use in connection with a prepared distal femur and a femoral implant.

16: A method for molding spacers suitable for use in knee arthoplasty at the point of care, said method comprising the steps of:
(a) assessing the knee joint of a patient undergoing knee arthoplasty to determine whether one or more spacers is desired;
(b) selecting one or more molds to form spacer lattices of desired shapes and thicknesses;
(c) applying liquid or gel biocompatible material to said mold or mold;
(d) allowing said biocompatible material to harden; and
(e) removing the resulting spacer lattice from said mold.

17: The method of claim 16, further comprising the step of shaping the spacer lattice after removal from the mold by cutting or grinding.

18: The method of claim 16, in which said mold is configured to form a spacer lattice in a pre-selected shape.

19: The method of claim 18, in which said pre-selected shape is a shape appropriate for use in connection with a prepared proximal tibia and a tibial implant.

20: The method of claim 18, in which said pre-selected shape is a shape appropriate for use in connection with a prepared distal femur and a femoral implant.
